(19) United States
(12) Patent Application Publication
(10) Pub. No.: US 2014/0104773 A1
(43) Pub. Date: Apr. 17, 2014

(54) ELECTRONIC APPARATUS

(71) Applicant: Kabushiki Kaisha Toshiba, Tokyo (JP)

(72) Inventor: Shigeyuki ITO, Tokorozawa-shi (JP)

(73) Assignee: Kabushiki Kaisha Toshiba, Tokyo (JP)

(21) Appl. No.: 13/974,999

(22) Filed: Aug. 23, 2013

Related U.S. Application Data
(63) Continuation of application No. PCT/JP2013/062991, filed on Apr. 30, 2013.

(30) Foreign Application Priority Data
Oct. 12, 2012 (JP) 2012-227168

(51) Int. Cl. G06F 1/16

(52) U.S. Cl. CPC G06F 1/1601
USPC 361/679.21

(57) ABSTRACT

According to one embodiment, an electronic apparatus includes a housing including an edge extending in a substantially horizontal direction, first and second protrusions in the housing, the third protrusion in a region between the first protrusion and the second protrusion, an optical sheet supported by the first to third protrusions, and a member. The third protrusion is further from the edge than the first and second protrusions. The member includes a first portion between the edge and the first protrusion and a second portion between the edge and the third protrusion.

### CROSS REFERENCE TO RELATED APPLICATIONS

This application is a Continuation Application of PCT Application No. PCT/JP2013/062991, filed Apr. 30, 2013 and based upon and claiming the benefit of priority from Japanese Patent Application No. 2012-227168, filed Oct. 12, 2012, the entire contents of all of which are incorporated herein by reference.

### FIELD

Embodiments described herein relate generally to electronic apparatuses including image display apparatuses.

### BACKGROUND

A liquid crystal display apparatus including an optical sheet has been proposed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram illustrating an image display apparatus according to a first embodiment;

FIG. 2 is an exemplary cross-sectional view illustrating the image display apparatus illustrated in FIG. 1;

FIG. 3 is an exemplary front view illustrating the inner surface of a back bezel of the image display apparatus illustrated in FIG. 1;

FIG. 4 is an exemplary rear view illustrating a middle frame illustrated in FIG. 2;

FIG. 5 is an exemplary front view illustrating the inner surface of the back bezel of the image display apparatus illustrated in FIG. 1;

FIG. 6 is an exemplary enlarged rear view illustrating a portion of the middle frame illustrated in FIG. 4;

FIG. 7 is an exemplary enlarged rear view illustrating another portion of the middle frame illustrated in FIG. 4;

FIG. 8 is an exemplary front view illustrating a first protrusion illustrated in FIG. 5;

FIG. 9 is an exemplary cross-sectional view illustrating the first protrusion taken along the line F9-F9 of FIG. 8;

FIG. 10 is an exemplary front view illustrating a third protrusion illustrated in FIG. 5;

FIG. 11 is an exemplary cross-sectional view illustrating the first protrusion taken along the line F11-F11 of FIG. 10;

FIG. 12 is an exemplary front view illustrating an image display apparatus according to a second embodiment; and

FIG. 13 is an exemplary cross-sectional view illustrating a fitting portion illustrated in FIG. 12.

### DETAILED DESCRIPTION

Various embodiments will be described hereinafter with reference to the accompanying drawings.

In general, according to one embodiment, an electronic apparatus comprises a housing comprising an edge extending in a substantially horizontal direction, first and second protrusions in the housing, the third protrusion in a region between the first protrusion and the second protrusion, an optical sheet supported by the first to third protrusions, and a member. The third protrusion is further from the edge than the first and second protrusions. The member includes a first portion between the edge and the first protrusion and a second portion between the edge and the third protrusion.

In this specification, some components are expressed by two or more terms. Those terms are just examples. Those components may be further expressed by another or other terms. And the other components which are not expressed by two or more terms may be expressed by another or other terms.

Hereinafter, exemplary embodiments will be described with reference to the accompanying drawings.

### First Embodiment

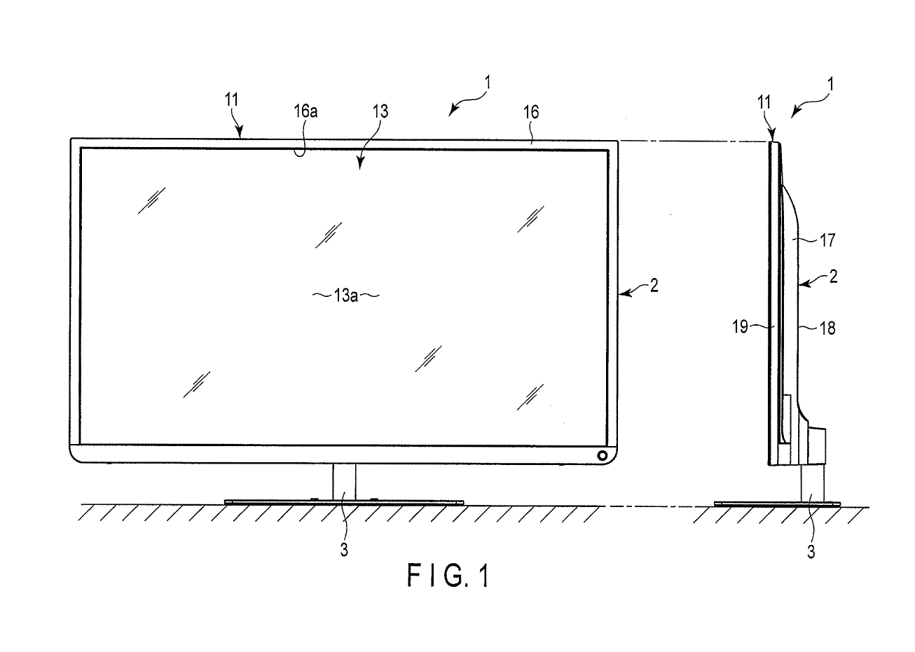

FIG. 1 illustrates an image display apparatus 1 according to a first embodiment. The image display apparatus 1 is an example of an “electronic apparatus”. This embodiment and the following embodiments are not limited to the image display apparatus 1, but can be widely applied to various electronic apparatuses.

The image display apparatus 1 includes an apparatus body 2 and a stand 3 which supports the apparatus body 2. The stand 3 is mounted on, for example, a television stand. The apparatus body 2 is supported by the stand 3 so as to rise in the vertical direction. In addition, the image display apparatus 1 may not include the stand 3 and may be fixed to, for example, a wall.

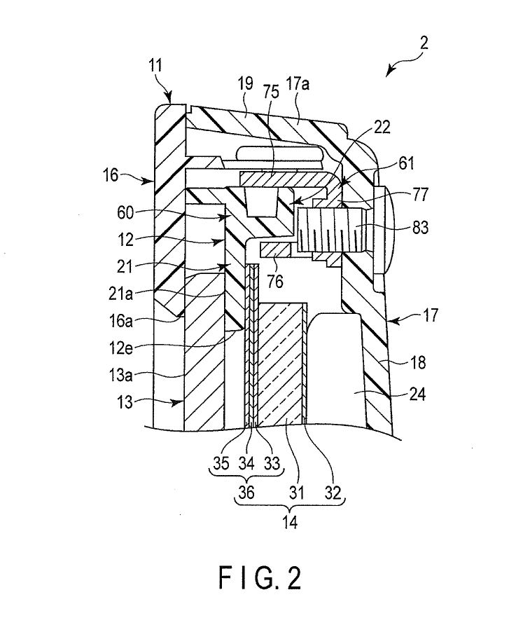

As illustrated in FIGS. 1 and 2, the apparatus body 2 includes a housing 11, a middle frame 12, a display panel 13, and a backlight module 14.

The housing 11 has, for example, a flat rectangular box shape. The housing 11 includes a front bezel 16 (i.e., a first member, a first cover, or a front cover) and a back bezel 17 (i.e., a second member, a second cover, or a back cover). The front bezel 16 and the back bezel 17 are made of, for example, a synthetic resin.

The front bezel 16 forms the side wall of the housing 11. The side wall rises in a substantially vertical direction so as to face a viewer. The front bezel 16 has a rectangular frame shape and an opening 16a through which a display screen 13a of the display panel 13 is exposed is provided in the front bezel 16.

As illustrated in FIGS. 1 and 2, the back bezel 17 is combined with the front bezel 16 so as to cover the front bezel 16 from the rear side. The back bezel 17 includes a rear wall 18 (i.e., back wall) and a circumferential wall 19. The rear wall 18 has, for example, a rectangular shape and rises so as to face the front bezel 16. The circumferential wall 19 extends from the edge of the rear wall 18 to the front bezel 16. The circumferential wall 19 is continuous in the circumferential direction of the rear wall 18 and the leading end thereof comes into contact with the edge of the front bezel 16. The rear wall 18 and the circumferential wall 19 of the back bezel 17 form a rear wall (i.e., back wall) and a circumferential wall of the housing 11, respectively.

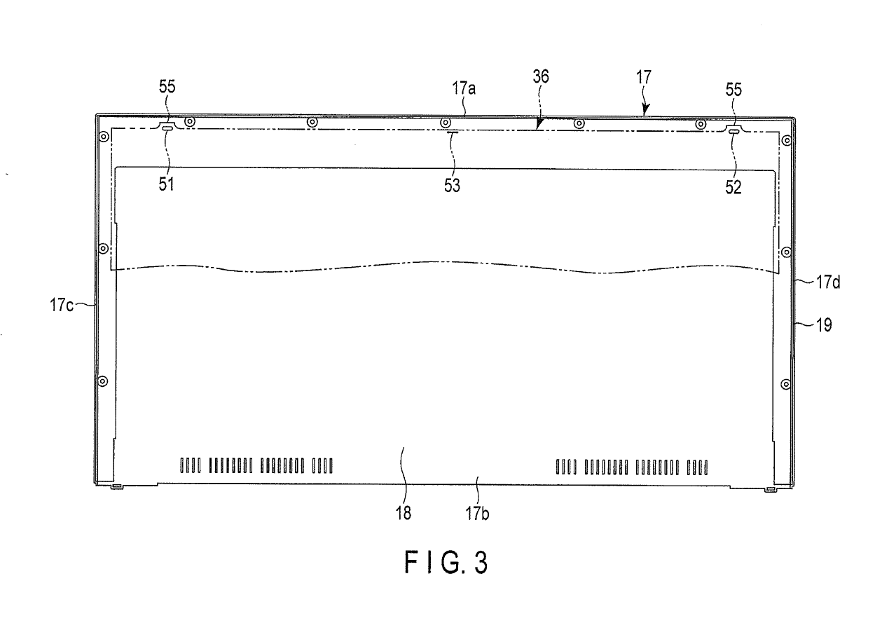

As illustrated in FIG. 3, the back bezel 17 includes first to fourth edges 17a, 17b, 17c, and 17d. The first edge 17a (i.e., a first end or an upper edge) and the second edge 17b (i.e., a second end or a lower edge) extend in a direction substantially parallel to the width direction of the housing 11, and are parallel to each other with a gap therebetween in a vertical direction. The third edge 17c (a third end or a left edge) and the fourth edge 17d (i.e., a fourth end or a right edge) extend in a substantially vertical direction, and are parallel to each other with a gap therebetween in the wide direction of the housing 11. The first to fourth edges 17a, 17b, 17c, and 17d of the back bezel 17 are examples of the upper, lower, left and right edges of the housing 11.

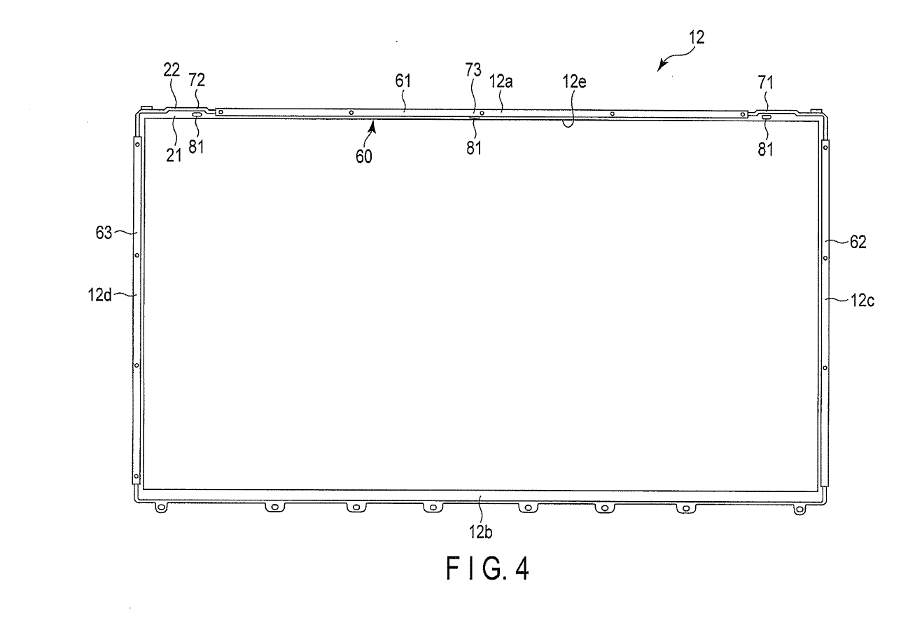

As illustrated in FIG. 2, the middle frame 12 (i.e., a reinforcing portion or an attachment portion) is accommodated in the housing 11 and is disposed between the front bezel 16 and the back bezel 17. The middle frame 12 is an example of a “member” attached in the housing 11. As illustrated in FIG. 4, the middle frame 12 is a rectangular frame having first to fourth sides 12a, 12b, 12c, and 12d.

The first side 12a (e.g., upper side) extends along the first edge 17a of the back bezel 17. The second side 12b (e.g., lower side) extends along the second edge 17b of the back bezel 17. The third side 12c (e.g., left side) extends along the third edge 17c of the back bezel 17. The fourth side 12d (e.g., right side) extends along the fourth edge 17d of the back bezel 17. The first to fourth sides 12a, 12b, 12c, and 12d define a rectangular opening 12e in cooperation with each other.

As illustrated in FIG. 2, the middle frame 12 includes a first wall 21 and a second wall 22. The first wall 21 extends in a substantially vertical direction and is provided between the display panel 13 and the backlight module 14. The first wall 21 includes a flat supporting surface 21a which faces the rear surface of the display panel 13. The supporting surface 21a receives the edge of the display panel 13 and supports the display panel 13.

The second wall 22 extends in a direction intersecting (e.g., substantially perpendicular to) the first wall 21. For example, the second wall 22 extends from the first wall 21 to the rear side in a substantially horizontal direction. The second wall 22 is inserted between the backlight module 14 and the circumferential wall 19 of the back bezel 17. The first wall 21 and the second wall 22 are continuous in the circumferential direction of the middle frame 12 so as to surround the opening 12e. The shape of the middle frame 12 will be described in detail below.

As illustrated in FIG. 2, the display panel 13 (i.e., a display body, a cell, or a display module) is accommodated in the housing 11. An example of the display panel 13 is a liquid crystal display panel, but is not limited thereto. In this specification, the “display panel” is a so-called open cell, for example, a flat plate that includes a surface protecting sheet, a liquid crystal cell, and a driving circuit and has a thickness of several millimeters, and does not include a light-emitting component such as a light guide plate.

As illustrated in FIG. 2, the display panel 13 is interposed and supported by the supporting surface 21a of the middle frame 12 and the inner surface of the front bezel 16. For example, cushion members may be provided between the display panel 13 and the supporting surface 21a of the middle frame 12 and between the display panel 13 and the inner surface of the front bezel 16.

As illustrated in FIG. 2, the backlight module 14 is accommodated in the housing 11. The backlight module 14 is interposed and supported between a holder 24 (e.g., a protruding portion) which is provided on the rear wall 18 of the back bezel 17 and the first wall 21 of the middle frame 12. The backlight module 14 includes a light guide plate 31, a reflecting sheet 32, a plurality of optical sheets 33, 34, and 35, and a light source module.

The light guide plate 31 is provided between the display panel 13 and the back bezel 17. The light guide plate 31 is, for example, a rectangular plate having substantially the same size as the display panel 13 and has translucency. The light guide plate 31 is disposed between the first wall 21 of the middle frame 12 and the rear wall 18 of the back bezel 17 and faces an opening 12e of the middle frame 12. The reflecting sheet 32 (i.e., rear sheet) is on the rear surface of the light guide plate 31. That is, the reflecting sheet 32 is provided between the light guide plate 31 and the rear wall 18 of the back bezel 17.

The plurality of optical sheets 33, 34, and 35 (i.e., front sheets) include the first prism sheet 33, the second prism sheet 34, and the light diffusion sheet 35. The first prism sheet 33 is on the front surface of the light guide plate 31. The second prism sheet 34 is on the front surface of the first prism sheet 33. The light diffusion sheet 35 is on the front surface of the second prism sheet 34.

In this embodiment, the three optical sheets 33, 34, and 35 form an optical sheet unit 36. The number of optical sheets on the front side of the light guide plate 31 is not limited to three, but at least one optical sheet may be provided according to a necessary function.

A light source module is provided below the light guide plate 31. Light emitted from the light source module is incident on the light guide plate 31 from the lower surface of the light guide plate 31. The light incident on the light guide plate 31 passes through the three optical sheets 33, 34, and 35 and travels toward the display panel 13. Among the light components incident on the light guide plate 31, the light component which travels toward the back bezel 17 is reflected from the reflecting sheet 32. The reflected light component passes through the light guide plate 31 and the three optical sheets 33, 34, and 35 and travels toward the display panel 13.

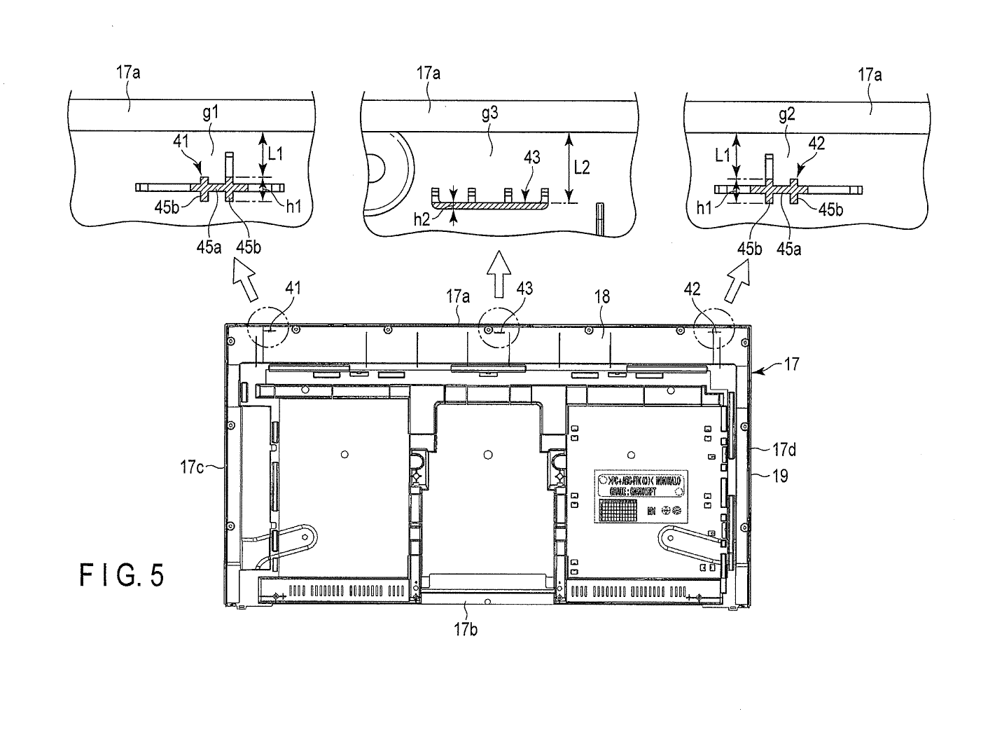

As illustrated in FIG. 5, first to third protrusions 41, 42, and 43 (i.e., ribs, fitting portions, supporter, positioning portions, or positioning ribs) are provided in the housing 11. The first to third protrusions 41, 42, and 43 protrude from the inner surface of the rear wall 18 of the back bezel 17 toward the inside of the housing 11. The first to third protrusions 41, 42, and 43 are separately provided in the substantially horizontal direction in the housing 11.

The first protrusion 41 is disposed at the upper left end (i.e., a left end region or a first region) of the housing 11. The second protrusion 42 is disposed at the upper right end (i.e., a right end region or a second region) of the housing 11. The third protrusion 43 is disposed in a region between the first protrusion 41 and the second protrusion. The third protrusion 43 is disposed at the center portion (i.e., a central region or a third region) of the upper end of the housing 11.

As illustrated in FIG. 5, the first protrusion 41 and the second protrusion 42 are a first distance L1 away from the first edge 17a (i.e., the upper edge of the housing 11) of the back bezel 17. The third protrusion 43 is further from the first edge 17a of the back bezel 17 than the first protrusion 41 and the second protrusion 42. That is, the third protrusion 43 is a second distance L2, which is more than the first distance L1, away from the first edge 17a of the back bezel 17.

That is, in this embodiment, the first to third protrusions 41, 42, and 43 are not arranged in a line in the horizontal direction. The third protrusion 43 which is disposed at the center is provided at the position (i.e., the position closer than the center of the display panel 13) lower than the first protrusion 41 and the second protrusion 42 which are disposed at both sides of the third protrusion 43.

In this way, a first gap g1 corresponding to the first distance L1 is provided between the first protrusion 41 and the first edge 17a of the back bezel 17. Similarly, a second gap g2 corresponding to the first distance L1 is provided between the second protrusion 42 and the first edge 17a of the back bezel 17. A third gap g3 corresponding to the second distance L2 is provided between the third protrusion 43 and the first edge 17a of the back bezel 17. The third gap g3 is greater than the first gap g1 and the second gap g2.

As illustrated in FIG. 5, the first protrusion 41 and the second protrusion 42 have substantially the same shape except that they are symmetric. The leading end of each of the first protrusion 41 and the second protrusion 42 includes, for example, a first portion 45a that extends in a substantially horizontal direction and two second portions 45b that extend in a direction (e.g., a substantially vertical direction or a direction substantially perpendicular to) intersecting the first portion 45a.

In this way, each of the first protrusion 41 and the second protrusion 42 has two intersection portions and has relatively high strength. Each of the first protrusion 41 and the second protrusion 42 has a higher strength (e.g., strength against a load in the vertical direction) than, for example, the third protrusion 43. Each of the first protrusion 41 and the second protrusion 42 has a first thickness h1 in the vertical direction.

The third protrusion 43 has a different shape from the first protrusion 41 and the second protrusion 42. The leading end of the third protrusion 43 includes only a portion that extends in a substantially horizontal direction, but does not include a portion extending in a substantially vertical direction. In this way, the third protrusion 43 has a second thickness h2 in the vertical direction. The second thickness h2 is less than the first thickness h1. The second thickness h2 less than the first thickness h1 contributes to ensuring the third gap g3 more than the first gap g1 and the second gap g2.

As illustrated in FIG. 3, each of the three optical sheets 33, 34, and 35 (hereinafter, referred to as the optical sheet unit 36) includes first to third openings 51, 52, and 53. The first opening 51 is provided at a position corresponding to the first protrusion 41 and the first protrusion 41 is inserted into the first opening 51. The second opening 52 is provided at a position corresponding to the second protrusion 42 and the second protrusion 42 is inserted into the second opening 52. The third opening 53 is provided at a position corresponding to the third protrusion 43 and the third protrusion 43 is inserted into the third opening 53.

In this way, the optical sheet unit 36 is hooked and supported (i.e., held) by the first to third protrusions 41, 42, and 43. The optical sheet unit 36 is hooked by the first to third protrusions 41, 42, and 43 and is positioned.

As illustrated in FIG. 3, projecting portions 55 (i.e., extension portions or protruding portions) are provided at the upper left and right ends of the optical sheet unit 36. The projecting portion 55 protrudes upward and is higher than, for example, the upper edge of the light guide plate 31. The projecting portion 55 protrudes upward and is higher than the upper edge of the central portion of the optical sheet unit 36. The first opening 51 and the second opening 52 are provided in the projecting portions 55. The third opening 53 is provided along the upper edge of the central portion of the optical sheet unit 36 in which the projecting portion 55 is not provided.

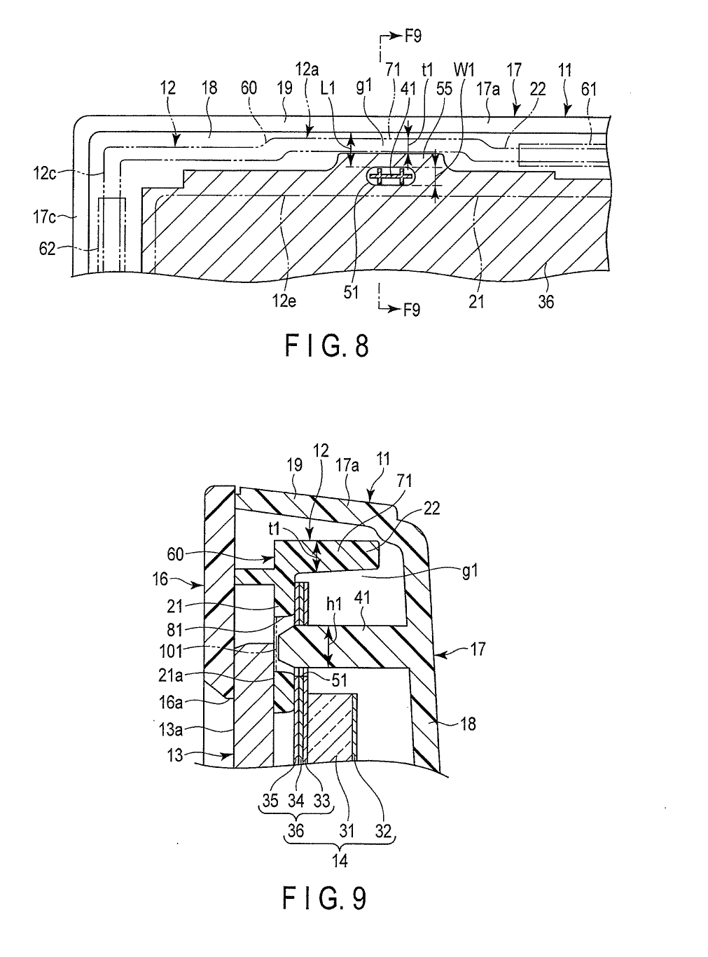

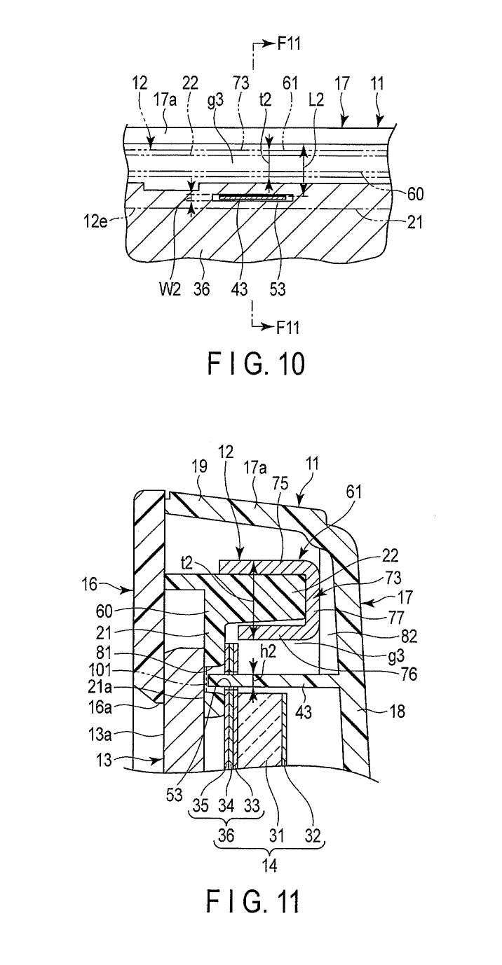

The first opening 51 and the second opening 52 are long holes which extend in a substantially horizontal direction. The first opening 51 has a width W1 corresponding to the thickness h1 of the first protrusion 41 (see FIG. 8). The second opening 52 has a width W1 corresponding to the thickness h1 of the second protrusion 42. The third opening 53 is a long hole (e.g., slit) which extends in a substantially horizontal direction. The third opening 53 has a width W2 corresponding to the thickness h2 of the third protrusion 43 (see FIG. 10). The third opening 53 is smaller than the first opening 51 and the second opening 52.

Next, the middle frame 12 will be described in detail.

As illustrated in FIG. 4, the middle frame 12 includes a frame body 60 (i.e., a main body or a frame portion) made of a synthetic resin and a plurality of metal reinforcing members 61, 62, and 63 (i.e., metal members) attached to the frame body 60. Each of the reinforcing members 61, 62, and 63 is partially provided in the frame body 60. The reinforcing members 61, 62, and 63 are, for example, metal plates with a higher strength than the middle frame 12.

As illustrated in FIGS. 2, 4, 6, and 7, the frame body 60 includes the first wall 21 and the second wall 22 (i.e., protruding portions or ribs) described above. The first wall 21 extends in a substantially vertical direction and is arranged along the rear surface of the display panel 13. The second wall 22 protrudes from the rear surface of the first wall 21 in a direction opposite to the supporting surface 21a. The second wall 22 extends along the outer circumferential edge of the first wall 21.

The second wall 22 is inserted into the above-described first to third gaps g1, g2, and g3. That is, the second wall 22 is inserted between the first to third protrusions 41, 42, and 43 and the first edge 17a of the back bezel 17. The reinforcing members 61, 62, and 63 are attached to the second wall 22.

The first reinforcing member 61 is attached to a substantially central portion of the first side 12a of the middle frame 12 and extends along the first side 12a. The first reinforcing member 61 is not provided at the left and right ends of the first side 12a. Similarly, the second reinforcing member 62 is attached to a substantially central portion of the third side 12c of the middle frame 12 and extends along the third side 12c. The second reinforcing member 62 is not provided at the upper and lower ends of the third side 12c. The third reinforcing member 63 is attached to a substantially central portion of the fourth side 12d of the middle frame 12 and extends along the fourth side 12d. The third reinforcing member 63 is not provided at the upper and lower ends of the fourth side 12d.

As illustrated in FIG. 3 and FIGS. 8 to 11, the middle frame 12 includes a first portion 71, a second portion 72, and a third portion 73. The first portion 71 is located between the first protrusion 41 and the first edge 17a of the back bezel 17. The second portion 72 is located between the second protrusion 42 and the first edge 17a of the back bezel 17. The third portion 73 is located between the third protrusion 43 and the first edge 17a of the back bezel 17.

The terms “first” to “third” may be appropriately changed as needed. For example, from another point of view, the second wall 22 includes a second portion 73 and a third portion 72. The second portion 73 is located between the third protrusion 43 and the first edge 17a of the back bezel 17. The third portion 72 is located between the second protrusion 42 and the first edge 17a of the back bezel 17.

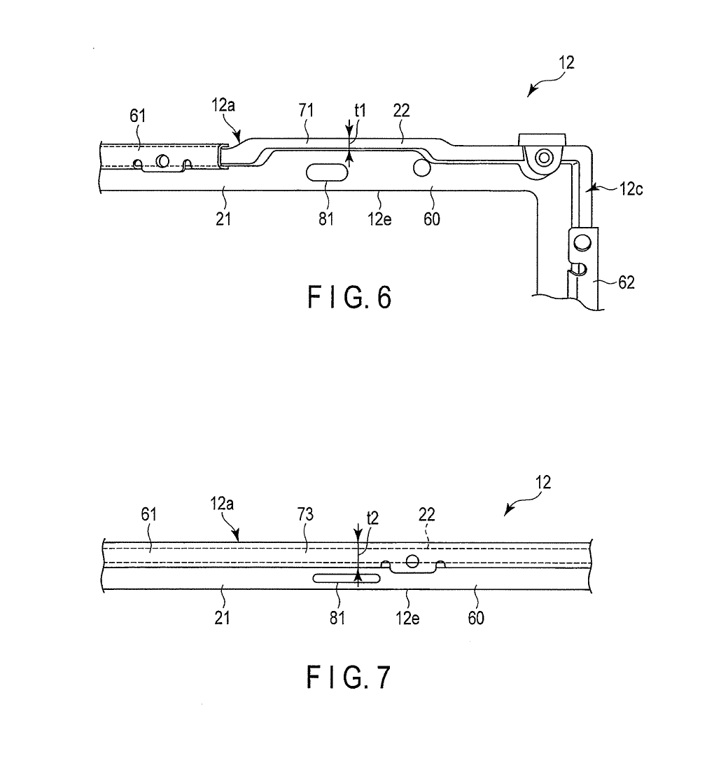

As illustrated in FIGS. 4 and 6, the first reinforcing member 61 is not provided in the first portion 71 and the second portion 72. The frame body 60 made of a synthetic resin is exposed from the first portion 71 and the second portion 72, and the first portion 71 and the second portion 72 have a first thickness t1 in the vertical direction. The first reinforcing member 61 is provided in the third portion 73.

As illustrated in FIGS. 2, 7, and 11, the first reinforcing member 61 includes a pair of holding portions 75 and 76 having the second wall 22 of the middle frame 12 interposed therebetween and a connection portion 77 which connects the holding portions 75 and 76. The first reinforcing member 61 is fitted to the second wall 22 so as to cover the second wall 22 from the rear side of the middle frame 12.

In this way, the frame body 60 made of a synthetic resin is reinforced by the first reinforcing member 61 and the rectangular shape thereof is maintained. The first reinforcing member 61 causes the third portion 73 to be thicker than the first portion 71 and the second portion 72. The third portion 73 has a second thickness t2 in the vertical direction. The second thickness t2 is greater (i.e., thicker) than the first thickness t1. The first reinforcing member 61 is attached to the second wall 22 of the frame body 60 and is disposed between the third protrusion 43 and the first edge 17a of the back bezel 17.

As illustrated in FIGS. 9 and 11, a plurality of openings 81 into which the leading ends of the first to third protrusions 41, 42, and 43 are inserted are provided in the first wall 21 of the middle frame 12. The openings 81 pass through the first wall 21 and face the supporting surface 21a. The leading ends of the first to third protrusions 41, 42, and 43 are inserted into the openings 81. Instead of the openings 81, a plurality of recesses 101 (e.g., concave portions) into which the leading ends of the first to third protrusions 41, 42, and 43 are inserted may be provided in the first wall 21 of the middle frame 12. In this embodiment, the plurality of openings 81 or recesses 101 are provided in the first wall 21 of the middle frame 12, but the embodiment is not limited thereto. The first wall 21 may include at least one opening or recess into which the leading end of any one of the first to third protrusions 41, 42, and 43 is inserted.

As illustrated in FIGS. 9 and 11, the leading ends of the first to third protrusions 41, 42, and 43 protrude from the front surface of the optical sheet unit 36. That is, the leading ends of the first to third protrusions 41, 42, and 43 are closer to the display panel 13 than the optical sheet unit 36.

The leading ends of the first to third protrusions 41, 42, and 43 are located on the rear side of the supporting surface 21a with a slight distance therebetween. That is, the leading ends of the first to third protrusions 41, 42, and 43 are further from the display panel 13 than the supporting surface 21a. Therefore, there is a gap between the leading ends of the first to third protrusions 41, 42, and 43 and the display panel 13. The first to third protrusions 41, 42, and 43 do not contact the display panel 13.

As illustrated in FIG. 11, a plurality of seating portions 82 are provided on the rear wall 18 of the back bezel 17. The seating portion 82 comes into contact with the reinforcing member 61 of the middle frame 12. In this way, the position of the middle frame 12 is determined. As illustrated in FIG. 2, the middle frame 12 is fixed to the front bezel 16 and the back bezel 17 by, for example, fixing tools 83 (e.g., screws) which are attached from the rear side of the back bezel 17.

According to this structure, it is possible to improve the strength of the electronic apparatus.

In recent years, the thickness of the electronic apparatus or the thickness of the frame has been reduced, which makes it difficult to ensure the strength of the electronic apparatus. For example, it is difficult to ensure the necessary thickness and shape of the middle frame due to restrictions in the dimensions of the frame. In a case in which the strength of the middle frame is low, for example, when the electronic apparatus is dropped by mistake, the display panel is likely to be detached or damaged due to the damage or warping of the middle frame.

Therefore, the electronic apparatus according to this embodiment includes the first to third protrusion 41, 42, and 43 which are provided in the housing 11, the optical sheets 33, 34, and 35 which are supported by the first to third protrusions 41, 42, and 43, and a member (e.g., the middle frame 12) which is accommodated in the housing 11. The third protrusion 43 is located in a region between the first protrusion 41 and the second protrusion 42 and is further from the first edge 17a of the housing 11 than the first protrusion 41 and the second protrusion 42. The member includes a first portion (i.e., first portion 71) which is located between the edge 17a of the housing 11 and the first protrusion 41 and a second portion (i.e., third portion 73) which is located between the edge 17a of the housing 11 and the third protrusion 43.

That is, in the structure according to this embodiment, the three protrusions 41, 42, and 43 are not arranged in a line in the horizontal direction, but the third protrusion 43 which is located at the center is further from the edge of the housing 11 than the first and second protrusions 41 and 42 which are located on both sides of the third protrusion 43. Therefore, a relatively large gap formed between the edge of the housing 11 and the third protrusion 43 is used to form a reinforcing structure. This structure makes it possible to improve the strength of the central portion of the housing 11 which is likely to have a lower strength than an angular portion of the housing 11. This contributes to improving the strength of the electronic apparatus.

This embodiment includes the reinforcing member 61 which is attached to the member and is disposed between the edge 17a of the housing 11 and the third protrusion 43. That is, a relatively large gap formed between the edge 17a of the housing 11 and the third protrusion 43 is used to form the reinforcing member 61, which makes it possible to improve the strength of the central portion of the housing 11.

In this embodiment, the member includes the first wall 21 which is provided between the display panel 13 and the optical sheet unit 36 and supports the display panel 13 and the second wall 22 which is inserted between the first to third protrusions 41, 42, and 43 and the edge 17a of the housing 11. According to this structure, the member supporting the display panel 13 is used to improve the strength of the housing 11.

In this embodiment, the third portion 73 of the middle frame 12 is thicker than the first portion 71. That is, a relatively large gap formed between the edge 17a of the housing 11 and the third protrusion 43 is used to thicken the central portion of the first side 12a of the middle frame 12. Therefore, it is possible to improve the strength of the central portion of the first side 12a of the middle frame with a lower strength than the angular portion.

In this embodiment, the thickness of the third protrusion 43 in the vertical direction is less than that of the first protrusion 41. An example of the “vertical direction” is a direction from the first edge 17a of the housing 11 to the third protrusion 43. According to this structure, it is possible to further increase the gap g3 between the edge of the housing 11 and the third protrusion 43. In this way, since the relatively large gap g3 is used to form the reinforcing structure, it is possible to further improve the strength of the central portion of the housing 11.

In this embodiment, the third portion 73 comprises the reinforcing member 61 made of a metal material and attached to the middle frame 12. The reinforcing member 61 makes the third portion 73 thicker than the first portion 71. According to this structure, it is possible to further strongly reinforce the central portion of the first side 12a of the middle frame.

In this embodiment, the middle frame 12 is provided with the openings 81 or the recesses 101 into the leading ends of the first to third protrusions 41, 42, and 43 are inserted. According to this structure, it is possible to increase the distance of the first to third protrusions 41, 42, and 43 from the front surface of the optical sheet unit 36 to a relatively large value. According to the first to third protrusions 41, 42, and 43 which relatively greatly protrude, the optical sheet unit 36 hooked by the protrusion 41, 42, and 43 is less likely to be taken off from the protrusions 41, 42, and 43. Therefore, it is possible to improve the assemblability of the electronic apparatus.

In this embodiment, the middle frame 12 includes the wall 21 having the supporting surface 21a which supports the display panel 13. The opening 81 passes through the supporting surface 21a of the wall 21. The leading ends of the first to third protrusions 41, 42, and 43 are inserted into the openings 81 and are further from the display panel 13 than the supporting surface 21a. According to this structure, since the protrusions 41, 42, and 43 are suppressed from contacting the display panel 13, a defect is less likely to occur in the display panel 13. This contributes to improving the reliability of the electronic apparatus.

### Second Embodiment

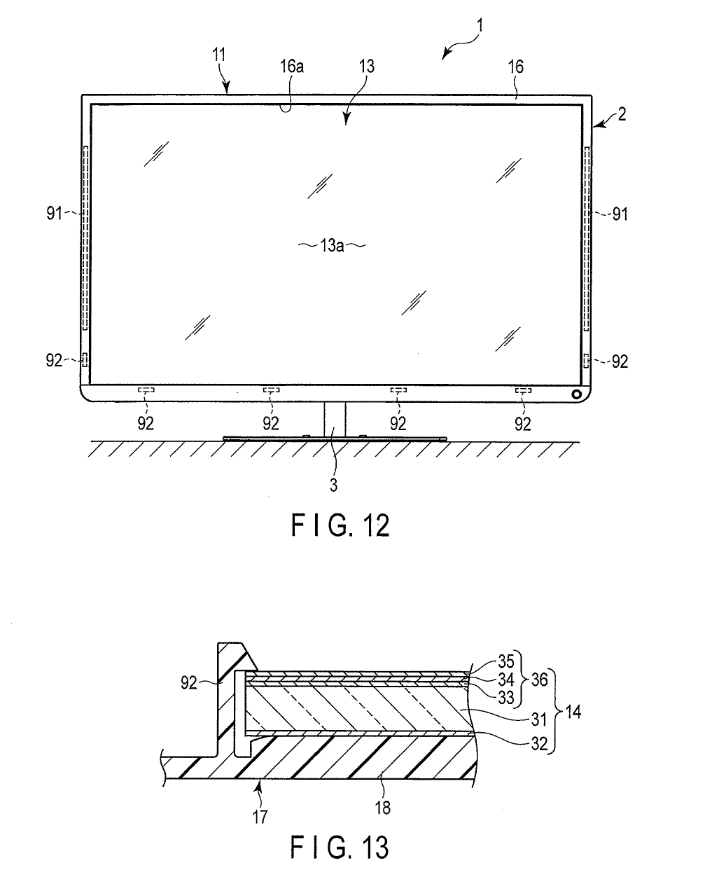

Next, an image display apparatus 1 according to a second embodiment will be described with reference to FIGS. 12 and 13. In the second embodiment, components having the same or similar functions as those in the first embodiment are denoted by the same reference numerals and the description thereof will not be repeated. In addition, structures other than the following structures are the same as those in the first embodiment.

As illustrated in FIGS. 12 and 13, in this embodiment, for example, ribs 91 (i.e., holding portions or rising wall ribs) having locking claws are provided on the inner surface of a back bezel 17. A light guide plate 31 is thicker than an optical sheet unit 36 and is rigid. The periphery of the light guide plate 31 is temporarily held by the ribs 91.

Fitting portions 92 (i.e., locking portions or locking claws) are provided at the lower end of the inner surface of the back bezel 17 and/or the lower left and right ends of the back bezel 17. As illustrated in FIG. 13, the leading end of the fitting portion 92 is hooked at the front surface of the optical sheet unit 36. In this way, the optical sheet unit 36 is temporarily held by the back bezel 17. Therefore, even when the back bezel 17 is turned over, the backlight module 14 is less likely to be taken off from the back bezel 17.

According to this structure, similarly to the first embodiment, it is possible to improve the strength of the electronic apparatus. In addition, according to this embodiment, it is possible to improve the manufacturability of the electronic apparatus. That is, for example, the electronic apparatus may be assembled as follows: the front bezel 16 is placed on a palette; internal mounting components are stacked on the front bezel 16; a separate rear housing portion (e.g., the back bezel 17 having a backlight module 14 attached thereto) which is temporarily assembled is stacked and assembled thereon; and the back bezel 17 is fixed to the front bezel 16 by screws. That is, it is possible to complete the assembly of the front bezel 16 and the back bezel 17 using a continuous assembly operation. Therefore, it is possible to greatly improve the manufacturability of the electronic apparatus.

The embodiments are not limited to the above-described embodiments, but the components according to the above-described embodiments may be changed without departing from the scope and spirit of the invention. In addition, a plurality of components according to the above-described embodiments may be appropriately combined with each other to form various structures. For example, some components may be removed from all components according to the above-described embodiments. In addition, components according to different embodiments may be appropriately combined with each other.

For example, the number of protrusions provided in the housing 11 is not limited to three. The number of protrusions may be equal to or more than, for example, four. In this embodiment, the reinforcing member 61 made of a metal material is attached to the frame body 60 and the third portion 73 is thicker than the first portion 71 and the second portion 72, but the embodiments are not limited thereto. For example, the middle frame 12 may not include the reinforcing member made of the metal material, but the entire middle frame 12 may be made of a synthetic resin. In addition, the third portion 73 may be formed with a large thickness so as to be thicker than the first portion 71 and the second portion 72.

The “member” inserted between the protrusions 41, 42, and 43 and the edge 17a of the housing 11 is not limited to the middle frame 12, but may be a reinforcing member or members having other functions. The third portion 73 of the middle frame 12 may not be thicker than the first portion 71 and the second portion 72. In this case, for example, another reinforcing member is attached using a relatively large gap between the third protrusion 43 and the edge 17a of the housing 11. Therefore, it is possible to improve the strength of the electronic apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing comprising an edge extending in a substantially horizontal direction;
a first protrusion in the housing;
a second protrusion in the housing;
a third protrusion in a region between the first protrusion and the second protrusion, the third protrusion being further from the edge than the first protrusion and the second protrusion;
an optical sheet supported by the first protrusion, the second protrusion, and the third protrusion; and
a member comprising a first portion between the edge and the first protrusion and a second portion between the edge and the third protrusion.

2. The electronic apparatus of claim 1, further comprising:
a reinforcing member attached to the second portion of the member and located between the edge and the third protrusion.

3. The electronic apparatus of claim 1, further comprising:
a display panel in the housing,
wherein the member comprises a first wall and a second wall, the first wall located between the display panel and the optical sheet and configured to support the display panel, the second wall comprising the first portion and the second portion and inserted between the first to third protrusions and the edge.

4. The electronic apparatus of claim 1,
wherein the optical sheet comprises a first opening into which the first protrusion is inserted, a second opening into which the second protrusion is inserted, and a third opening into which the third protrusion is inserted, and the optical sheet is hooked to the first to third protrusions.

5. The electronic apparatus of claim 1,
wherein the second portion is thicker than the first portion.

6. The electronic apparatus of claim 5,
wherein a distance between the second protrusion and the edge is substantially equal to a distance between the first protrusion and the edge, and
the member comprises a third portion between the edge and the second protrusion, the third portion thinner than the second portion.

7. The electronic apparatus of claim 5,
wherein a thickness of the third protrusion in a vertical direction is less than that of the first protrusion.

8. The electronic apparatus of claim 5,
wherein the second portion comprises a reinforcing member attached to the member, and the second portion is thicker than the first portion.

9. The electronic apparatus of claim 1,
wherein the member comprises an opening or a recess into which a leading end of any one of the first protrusion, the second protrusion and the third protrusion is inserted.

10. The electronic apparatus of claim 9, further comprising:
a display panel in the housing,
wherein the member comprises a wall, the wall comprising a supporting surface supporting the display panel,
the opening is located in the wall and passes through the supporting surface, and
the leading end of any one of the first protrusion, the second protrusion, and the third protrusion is inserted into the opening and is further from the display panel than the supporting surface.

11. The electronic apparatus of claim 1,
wherein the electronic apparatus is an image display apparatus.
